(19) United States
(12) Patent Application Publication
(10) Pub. No.: US 2026/0119701 A1
(43) Pub. Date: Apr. 30, 2026

(54) SYSTEMS AND METHODS FOR PROTECTING THE IDENTITY OF USERS AND ENTITIES

(71) Applicant: Wells Fargo Bank, N.A., San Francisco, CA (US)

(72) Inventors: Arushi S. Joshi, San Francisco, CA (US); Ashmita Regmi, San Francisco, CA (US); Anthony Stimola, San Francisco, CA (US); Uma Anupindi, San Francisco, CA (US); Ian T. Staley, San Francisco, CA (US); Anita Sukur, Minneapolis, MN (US)

(73) Assignee: Wells Fargo Bank, N.A., San Francisco, CA (US)

(21) Appl. No.: 18/929,346

(22) Filed: Oct. 28, 2024

(51) Int. Cl. G06F 21/62

(52) U.S. Cl. CPC G06F 21/6245

(57) ABSTRACT

Methods, systems, and computer-readable medium for protecting the identity of users and entities. One method includes receiving an identity pass request for a user, receiving at least attributes associated with the user, transmitting an authentication request for at least one verifiable credential of the user, and receiving the at least one verifiable credential. The method includes generating an identity pass including a set of identity tokens and the at least one verifiable credential. The method includes generating a GUI, receiving a data request, verifying the verifiable credential, and determining a first subset of the attributes corresponding with protected information and a second subset of the attributes corresponding with unprotected information. The method includes accessing a data storage storing the identity pass and transmitting the unprotected information to satisfy the request, or, permitting access to the unprotected information to satisfy the request. The method further includes updating a usage log.

### BACKGROUND

Various identity verification methods are used to manage identities of users and entities. Existing systems often exhibit interoperability limitations and require users to manage multiple credentials across different platforms and services. This fragmentation creates an inefficient identification verification process and increases the likelihood of security vulnerabilities.

### SUMMARY

Some arrangements relate to a system including a computing system including at least one processor and at least one memory coupled to the at least one processor. The at least one processor may be configured to receive an identity pass request for a user, receive at least attributes associated with the user, transmit an authentication request for at least one verifiable credential of the user, receive the at least one verifiable credential of the user, and generate an identity pass including a set of identity tokens and the at least one verifiable credential. The set of identity tokens includes at least a first identity token including attributes of the user. The at least one processor may be configured to generate a graphical user interface (GUI) including a representation of the identity pass, the identity pass including one or more interactive elements. Selection of the one or more interactive elements includes updating the representation corresponding with the identity pass. The at least one processor may be configured to receive a data request corresponding with the at least one verifiable credential or at least one of the set of identity tokens of the identity pass. The data request may be for an exchange using an exchange instrument, by the user, or providing at least one of the attributes of the user. The at least one processor may be configured to verify the verifiable credential based at least on verifying a cryptographic object of the verifiable credential, verifying an issuer of the verifiable credential, or verifying a status of the verifiable credential, and responsive to verifying the verifiable credential, determine, based at least on the data request, a first subset of the attributes corresponding with protected information of the user and a second subset of the attributes corresponding with unprotected information of the user. The at least one processor may be configured to access a data storage storing the identity pass, wherein accessing includes querying for unprotected information of the user corresponding with the at least one of the set of identity tokens. The query returns the unprotected information to satisfy the exchange or permit access to at least one of the attributes of the user. The at least one processor may be configured to transmit, to a second computing system, the unprotected information to satisfy the request, or, permit access, to the second computing system, to the unprotected information to satisfy the request, and update a usage log of the identity pass corresponding with the data request.

In some arrangements, updating the usage log of the identity pass includes presenting a usage log, and updating the usage log of the identity pass includes updating the representation of the identity pass in the GUI. In some arrangements, the identity pass is stored on a distributed ledger and the distributed ledger is a semi-private distributed ledger allowing selective access to the distributed ledger. In some arrangements, the authentication request is transmitted to the user, a government entity, or third-party. In some arrangements, the query returns the unprotected information. The at least one processor is further configured to determine, based at least on the data request, a portion of the unprotected information necessary to satisfy the data request. In some arrangements, the at least one processor is further configured to verify, using at least one authentication protocol, the data request, and transmit, to the second computing system, the at least one of the set of tokens.

One arrangement relates to a method. The method includes receiving an identity pass request for a user, receiving at least attributes associated with the user, transmitting an authentication request for at least one verifiable credential of the user, receiving the at least one verifiable credential of the user, and generating an identity pass including a set of identity tokens and the at least one verifiable credential. The set of identity tokens includes at least a first identity token including attributes of the user. The method includes generating a GUI including a representation of the identity pass, the identity pass including one or more interactive elements, wherein selection of the one or more interactive elements includes updating the representation corresponding with the identity pass. The method includes receiving a data request corresponding with the at least one verifiable credential or at least one of the set of identity tokens of the identity pass, wherein the data request may be for an exchange using an exchange instrument, by the user, or providing at least one of the attributes of the user. The method includes verifying the verifiable credential based at least on verifying a cryptographic object of the verifiable credential, verifying an issuer of the verifiable credential, or verifying a status of the verifiable credential. The method includes, responsive to verifying the verifiable credential, determining, based at least on the data request, a first subset of the attributes corresponding with protected information of the user and a second subset of the attributes corresponding with unprotected information of the user. The method includes accessing a data storage storing the identity pass, wherein accessing includes querying for unprotected information of the user corresponding with the at least one of the set of identity tokens, and wherein the query returns the unprotected information to satisfy the exchange or permit access to at least one of the attributes of the user. The method includes transmitting, to a computing system, the unprotected information to satisfy the request, or, permitting access, to the computing system, to the unprotected information to satisfy the request, and updating a usage log of the identity pass corresponding with the data request.

In some arrangements, the method further includes receiving a second data request for supplementary information associated with the user. The method includes, responsive to user approval, receiving the supplementary information. The method includes generating at least a second identity token of the set of identity tokens including the supplementary information, and updating the identity pass based at least on the second identity token. In some arrangements, the supplementary information is a tax history or credit score. In some arrangements, the identity pass is stored on a distributed ledger and the distributed ledger is a semi-private distributed ledger allowing selective access to the distributed ledger. In some arrangements, the identity pass request is generated responsive to an onboarding process.

One arrangement relates to at least one non-transitory processor-readable medium including processor-readable instructions such that, when executed by at least one processor, causes the at least one processor to receive an identity pass request for a user, receive at least attributes associated with the user, transmit an authentication request for at least one credential of the user, receive the at least one credential of the user, and generate an identity pass including a set of identity tokens and the at least one credential. The set of identity tokens includes at least a first identity token including attributes of the user. The processor-readable instructions further cause the at least one processor to generate a graphical user interface (GUI) including a representation of the identity pass, the identity pass including one or more interactive elements. Selection of the one or more interactive elements includes updating the representation corresponding with the identity pass. The processor-readable instructions further cause the at least one processor to receive a data request corresponding with the at least one verifiable credential or at least one of the set of identity tokens of the identity pass. The data request may be for an exchange using an exchange instrument, by the user, or providing at least one of the attributes of the user. The processor-readable instructions further cause the at least one processor to verify the verifiable credential based at least on verifying a cryptographic object, an issuer, or a status of the at least one credential, and responsive to verifying the credential, determine, based at least on the data request, a first subset of the attributes corresponding with protected information of the user and a second subset of the attributes corresponding with unprotected information of the user. The processor-readable instructions further cause the at least one processor to access a data storage storing the identity pass. Accessing includes querying for unprotected information of the user corresponding with the at least one of the set of identity tokens. The query returns the unprotected information to satisfy the exchange or permit access to at least one of the attributes of the user. The processor-readable instructions further cause the at least one processor to transmit, to a second computing system, the unprotected information to satisfy the request, or, permit access, to the second computing system, to the unprotected information to satisfy the request, and, update a usage log of the identity pass corresponding with the data request.

In some arrangements, the at least one processor is further configured to receive a second data request for supplementary information associated with the user, and responsive to user approval, receive the supplementary information. The at least one processor is further configured to generate at least a second identity token of the set of identity tokens including the supplementary information, and update the identity pass based at least on the second identity token. In some arrangements, the identity pass is stored on a distributed ledger and the distributed ledger is a semi-private distributed ledger allowing selective access to the distributed ledger. In some arrangements, the query returns the unprotected information and the at least one processor is further configured to determine, based at least on the data request, a portion of the unprotected information to satisfy the data request. In some arrangements, updating the representation of the identity pass includes presenting the usage log, and updating the usage log of the identity pass includes updating the representation of the identity pass in the GUI. In some arrangements, the at least one processor is further configured to generate a second identity token of the set of identity tokens including access credentials corresponding to the exchange instrument.

### BRIEF DESCRIPTION OF THE DRAWINGS

FIG. 1 is a block diagram depicting an example of an identity pass system, according to some arrangements;

FIG. 2 is a flowchart for a method of generating an identity pass that may be implemented or performed by one or more components of FIG. 1, according to some arrangements;

FIGS. 3A-3D are example graphical user interfaces that may be generated by one or more components of FIG. 1, according to some arrangements;

FIGS. 4A-4D are example graphical user interfaces that may be generated by one or more components of FIG. 1, according to some arrangements;

FIG. 5 is an example graphical user interface that may be generated by one or more components of FIG. 1, according to some arrangements;

FIG. 6 is a block diagram illustrating an example computing system suitable for use with various components of FIG. 1 according to the various arrangements described herein.

It will be recognized that some or all of the figures are schematic representations for purposes of illustration. The figures are provided for the purpose of illustrating one or more arrangements with the explicit understanding that they will not be used to limit the scope or the meaning of the claims.

### DETAILED DESCRIPTION

Referring generally to the Figures, the systems and methods described herein relate to an identity pass (e.g., digital identity pass, etc.) that includes digital credentials (e.g., government-issued IDs, educational qualifications, biometric data, etc.) and user information for verification and information sharing. The systems and methods disclosed herein are configured for use in identity verification and information sharing processes. In many systems, user information is collected and provided to different provider institutions, platforms, applications, enterprises, and individual devices during transactions or interactions. For example, a user may provide personal information to apply for a financial service. In another example, a user may submit their government-issued ID when registering for an online service. In yet another example, biometric data may be collected by a mobile device to authenticate a user's identity.

Verifying and sharing user information across different systems introduces security vulnerabilities and inefficiencies in communication and processing. For example, different institutions may require users to re-submit the same personal data in varying formats, leading to redundant data input and transmission. In another example, integration between platforms may involve incompatible systems, resulting in delays in the verification process. In yet another example, decentralized storage across platforms creates technical problems in securely accessing or updating user information across multiple systems.

In some arrangements, users submit personal information across multiple entities, increasing the vulnerability of unauthorized access, data breaches, or identity theft. For example, multiple data points stored in different locations increase the attack surface for malicious entities attempting to compromise sensitive user data. In another example, the transmission of personal information between different systems without sufficient encryption may lead to interception by unauthorized parties. In yet another example, inconsistencies in security measures across institutions create vulnerabilities in the protection of sensitive user data. Accordingly, there is a need for a technical solution that consolidates and integrates digital credentials into a secure identity pass. The systems and methods described herein reduce redundancies, improves verification efficiencies, and improve the security of user information across interconnected systems and networks.

Additionally, the systems and methods described herein relate to an identity pass (e.g., digital identity pass, etc.) including digital credentials (e.g., government-issued IDs, education qualifications, biometric data, etc.) and user information for verification and user information sharing. A person or entity may use the systems and methods disclosed herein for identity verification and information sharing. For example, a user may provide personal information to apply for a financial service. However, verifying and sharing user information across different provider institutions, platforms, applications, enterprises, and individual devices may be inefficient and cumbersome to users and service providers. Further, as users are often required to provide extensive personal information to multiple entities, users are vulnerable to fraud, data breaches, or identity theft.

As described herein, the identity pass may be defined in a decentralized ID document (DID) (e.g., a JavaScript Object Notation (JSON) file, etc.) which includes pointers to documents, systems of record (SORs), biometric, activity logs, verifiable credentials, and the like. The DID may include a description, a set of public keys for verification, a set of authentication methods for authentication, a set of service end points for interaction, a timestamp for audit history, a signature for integrity, and the like. The identity pass may be included in a digital wallet of the user. The digital identity pass may therefore consolidate various digital credentials and provide improved user control over who may access information. To improve the efficiency and effectiveness of digital transactions, the identity pass integrates digital credentials and user credential to allow different networks (across institutions, platform, application, enterprises, etc.) to share user information and establish a verified identity for a user to be shared across those networks.

The identity pass of a user may be generated during an onboarding process, such as an account opening, or loan application, which may include a data collection process and/or risk assessment process. Creating the identity pass may also include pulling records and information from various data sources to collect user information. A user may have multiple identity passes associated with their identity for various applications, such as a business profile, a corporate profile, or a personal profile. The verified identity of a user may be identified using the identity pass, which may be provided to different networks to identify the user. Content of the identity pass may then be shared for other applications and processes. For example, if a user were to apply for a loan, user information provided for a previous loan application may be used to auto populate data fields in a new loan application. Therefore, the user may be not required to re-enter information, simplifying the loan application process for the user, as well as reducing instances of data entry errors.

While the identity pass may be shared across different networks, the identity pass may also be limited to a single network. For example, one institution may issue the identity pass and rely on the identity pass. For example, a financial institution may build an identity pass for a user upon opening an account, and the identity pass may be used to open other accounts within the financial institution, or apply for various programs and services within the financial institution.

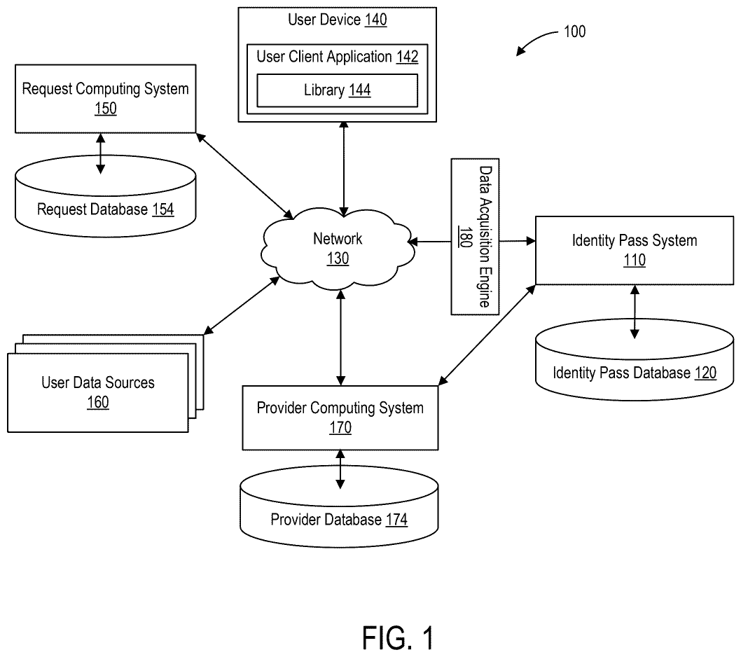

Referring to FIG. 1, a block diagram depicting an example of an identity pass system 110 and a computing environment 100 is shown, according to some arrangements. As shown, the computing environment 100 includes the identity pass system 110 coupled to an identity pass database 120. The identity pass system 110 may be coupled, via the data acquisition engine 180, to a plurality of devices and/or systems including, user devices 140, request computing system 150, data sources 160, and a provider (e.g., a provider institution) computing system 170. The plurality of devices and/or systems 140, 150, 170, and/or the data sources 160 may exchange and/or route (e.g., provide) data, information, etc. over a network 130. The data acquisition engine 180 may provide a single application programming interface (API) or multiple APIs to access various data generated, stored, and exchanged by the devices and systems 140, 150, 160, and 170. In various arrangements, the identity pass system 110 and the provider computing system 170 may be implemented as separate systems or integrated within a single system (e.g., provider computing system 170 may be configured to incorporate some or all of the functions/capabilities of the identity pass system 110). In some arrangements, the identity pass database 120 and provider database 174 may be implemented as separate databases or integrated within a single database (e.g., provider database 174 may be configured to store some or all of the data/datasets of the identity pass database 120).

The user devices 140 may be associated with (e.g., owned by, associated with, or otherwise used by) a user to perform various actions (e.g., initiating a loan application, opening an account, etc.) and/or access various data in which actions may be provided and performed over a network 130. As used herein, the “user” refers to an individual operating the user device 140 who owns, manages, or may be otherwise associated with the user device 140. Thus, as described herein, the user may be a customer of one or more institutions or platforms associated with the request computing system 150. The user device 140 may be used to send data to the identity pass system 110 or may be used to perform various actions, including performing actions at a merchant, accessing applications (e.g., a mobile application), and/or any other action. The user device 140 may be a mobile or stationary computing device including, but not limited to, a mobile phone, a tablet, a laptop, a wearable device, a virtual/augmented reality (VR/AR) device, and/or other suitable mobile user computing devices capable of accessing and communicating using local and/or global networks. Wearable computing devices refer to types of devices that an individual wears, including, but not limited to, a watch (e.g., a smart watch), glasses (e.g., eyeglasses, sunglasses, smart glasses, etc.), bracelet (e.g., a smart bracelet), etc.

The user device 140 is shown to include a user client application 142 (also referred to herein as a mobile application and/or provider institution client application). The mobile application 142 may be provided by, coupled to, and supported by, at least partially, the provider computing system 170. In another arrangement, the mobile application 142 may be configured as a mobile banking application, which may also be provided, coupled to, and supported, at least partly, by the provider computing system 170. In some arrangements, the mobile application 142 may be a standalone application or be incorporated with an existing application of the user device 140 (e.g., integrated into a mobile banking application, a service provider application, etc.). The mobile application 142 may be downloaded by the user device 140 prior to its usage, hard-coded into a memory of the user device 140, or be a network-based or web-based interface application such that the provider computing system 170 may provide a web browser to access the application, which may be executed remotely from the user device 140. For example, the mobile application 142 may be downloaded to the user device 140 and provided by the provider computing system 170 via an app store for download. The mobile application 142 may be structured as a mobile banking application. The mobile application 142 may be developed and maintained (e.g., provided with software updates on a regular or semi-regular basis) by the provider institution via the provider computing system 170. Accordingly, the user device 140 may include software and/or hardware capable of implementing a network-based or web-based application. For example, in some instances, the mobile application 142 includes software such as HTML, XML, WML, SGML, PHP (Hypertext Preprocessor), CGI, and like languages.

In the latter web-based instance, the user may have to log onto or access the web-based interface before usage of the application. Further, and in this regard, the mobile application 142 may be supported by the provider computing system 170 via one or more servers, processors, network interface circuits, etc. that transmit applications for use to the user device 140. Furthermore, prior to use of the mobile application 142 and/or at various points throughout the use of the mobile application 142, the user may provide various authentication information or log-in credentials (e.g., a password, a pass code, a personal identification number (PIN), a fingerprint scan, a retinal scan, a voice sample, a face scan, any other type of biometric security scan) to ensure that the user associated with the user device 140 may be authorized to use the mobile application 142.

The mobile application 142 includes a library 144. The library 144 may be structured as a repository (e.g., a file in the mobile application 142 for storing information, instructions in the mobile application 142 for storing information in a memory device of the user device 140, etc.). Furthermore, the library 144 may include an API configured for communication with the identity pass system 110, in particular, the user interface 114. In another example, the library 144 may be an SDK that includes an API, a debugger, and IDE, and so on. In some arrangements, the library 144 includes one or more libraries having reusable functions that interface with a particular system software (e.g., iOS, Android, Linux, etc.). The library 144 may facilitate embedding functionality in mobile application 142.

The network 130 may include any combination of a wired and/or wireless network. Therefore, the network 130 may be a local area network (LAN), a wide area network (WAN) (e.g., the Internet), a telephone network, such as the Public Switched Telephone Network (PSTN), a wireless link, an intranet, the Internet, a proprietary banking network, or combinations thereof. The network 130 may facilitate communication between various nodes, such as the identity pass system 110 and user devices 140. In some arrangements, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6. The network 130 may include various network devices (nodes) communicatively linked to form one or more data communication paths between participating devices. Each networked device includes at least one network interface for receiving and/or transmitting data, typically as one or more data packets. An illustrative network 130 may be the Internet; however, other networks may be used. The network 130 may be an autonomous system (AS), i.e., a network that may be operated under a consistent unified routing policy (or at least appears to from outside the AS network) and may be generally managed by a single administrative entity (e.g., a system operator, administrator, or administrative group).

Referring to the request computing system 150, at least one (e.g., each) request computing system 150 may be associated with (e.g., owned by, managed by, controlled by, etc.) an institution (e.g., financial institution, educational institution, etc.), such as the provider institution, or one or more merchants. As used herein, a “merchant” refers to a company, business, or other entity including an individual that provides goods and/or services. For example, the merchant may be a hairdresser, restaurant (e.g., bar, dive, diner, etc.), stadium (e.g., hosting sports, concerts, etc.), food truck, wireless phone carrier, movie theater, store (e.g., small, medium, big-box, chain, etc.), and so on. Accordingly, the merchant may be an individual (e.g., small business owner) or a larger entity (e.g., fortune 500 company, business, institution). The request computing system 150 may be configured to receive a request for an exchange (e.g., transaction) using an exchange instrument (e.g., a tool or mechanism that facilitates transactions between parties, payment instrument, credit/debit card, checks, digital wallets, cryptocurrencies, contracts, futures and options, bonds, stocks, mobile payments, credits, securities, exchange-traded funds (ETFs), mortgage instruments, digital currencies, exchange-traded derivatives, agreements, tokenized assets, loans, direct deposits, etc.), or for user information. For example, the request may be a request from the user device 140 for one or more goods and/or services provided by merchant.

The request computing system 150 may be used to perform various actions and/or access user information, some of which may be provided over the network 130. The request computing system 150 may be used to send and receive data (e.g., exchange information) with the identity pass system 110. The request computing system 150 may include one or more processing circuits or systems that have one or more processors coupled to one or more transitory and/or non-transitory storage mediums and/or memory devices (e.g., any computer-readable storage media, such as a magnetic storage, optical storage, flash storage, RAM, and so on).

The one or more data sources 160 may be one or more computing systems, which are third-parties relative to the request computing system 150 and provider computing system 170, that are configured to provide and store data to at least one of the user device 140, identity pass system 110, or provider computing system 170. The data sources 160 may function as data aggregators. In some arrangements, the data sources 160 may provide information associated with a particular user. User information may include personal identification information, contact information, biometric data, government-issued identifications, digital credentials, licenses, financial information, health information, security information, social profiles, and the like. The data sources 160 may receive authentication request from the identity pass system 110 to authenticate a verifiable credential. In some arrangements, the data sources 160 may be excluded from the computing environment 100.

The computing environment 100 is shown to further include a provider computing system 170 associated with (e.g., managed by, controlled by, owned by, etc.) a provider institution. In some arrangements, the provider institution may be a financial institution capable of providing one or more financial products and services, such as providing various accounts, such as a demand deposit account, lending, money transfers, issuing credit and/or debit cards, wealth management, etc. Among other capabilities, the associated provider computing system 170 may be structured to provide or otherwise facilitate providing the one or more financial products and services to customers. As such, the provider institution may also be referred to as a financial institution herein that provides banking services to customers. For example, customers view account balances, apply for loans, and the like, via the provider computing system 170. As described herein, the provider computing system 170 may be structured to support at least some of the functions and services described below. The provider computing system 170 may be implemented using a computing system, such as a discrete server, a group of two or more computing devices/servers, a distributed computing network, a cloud computing network, and/or another type of computing system capable of accessing and communicating using local and/or global networks (e.g., the network 130).

The provider computing system 170 may be configured to send data to and exchange information with the identity pass system 110. The provider computing system 170 may also be configured to store data/information of customers in a provider database 174. Data stored in the provider database 174 may include personal information (e.g., names, addresses, phone numbers, and so on), authentication information (e.g., username/password combinations, device authentication tokens, security question answers, unique client identifiers, biometric data, geographic data, social media data, and so on), and/or financial information (e.g., token information, account numbers, account balances, voucher identifiers, available credit, credit history, exchange histories, voucher histories, and so on) regarding users and associated accounts of the users.

The provider computing system 170 may include one or more processors (e.g., any general purpose or special purpose processor), and include and/or be operably coupled to one or more transitory and/or non-transitory storage mediums and/or memory devices (e.g., any computer-readable storage media, such as a magnetic storage, optical storage, flash storage, RAM, and so on). The memory device may store instructions, code, logic, program logic, etc. that may be executed by the provider computing system 170 to perform various functions described herein. Thus, the provider computing system 170 may be configured to have various capabilities enabling various functionalities. In various arrangements, it should be appreciated that provider of the provider computing system 170 may own and maintain the identity pass system 110.

The computing environment 100 is shown to include a data acquisition engine 180. In various arrangements, the identity pass system 110 may be communicatively and operatively coupled to the data acquisition engine 180. The data acquisition engine 180 may include one or more processing circuits configured to execute various instructions. In various arrangements, the data acquisition engine 180 may be configured to facilitate communication (e.g., via network 130) between the identity pass system 110, the identity pass database 120, and systems and devices described herein (e.g., user devices 140, request computing system 150, data sources 160, provider computing system 170). Thus, the data acquisition engine 180 may additionally include a network interface, and be structured as an interface for communications between the identity pass system 110 and other systems and components in FIG. 1. In other arrangements, the data acquisition engine 180 may be excluded and the identity pass system 110 communicates directly with the request computing system 150, provider computing system 170, data sources 160, and/or user device 140. Regarding the data acquisition engine 180, the facilitation of communication may be implemented as an application programming interface (API) (e.g., REST API, Web API, customized API), batch files, SDK, and/or queries. In various arrangements, the data acquisition engine 180 may also be configured to control access to resources of the identity pass system 110 and identity pass database 120.

The API may be used by the data acquisition engine 180 and/or computing systems to exchange data and make function calls in a structured format. The API may be configured to specify an appropriate communication protocol using a suitable electronic data interchange (EDI) standard or technology. The EDI standard (e.g., messaging standard and/or supporting technology) may include any of an SQL data set, a protocol buffer message stream, an instantiated class implemented in a suitable object-oriented programming language, an XML file, a text file, an Excel file, a web service message in a suitable web service message format (e.g., representational state transfer (REST), simple object access protocol (SOAP), web service definition language (WSDL), JavaScript object notation (JSON), XML remote procedure call (XML RPC)). As such, EDI messages may be implemented in any of the above or using another suitable technology.

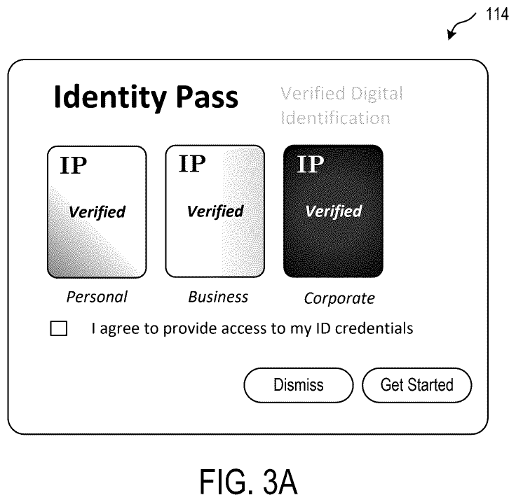

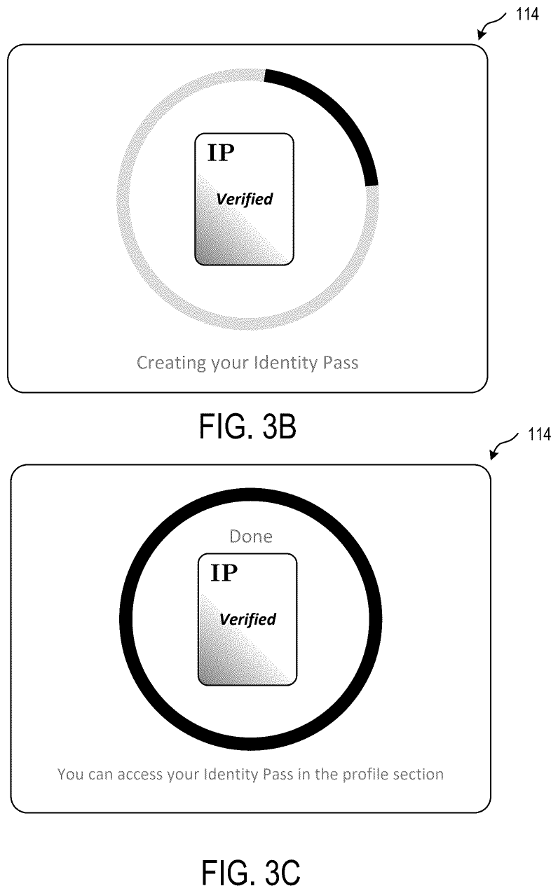

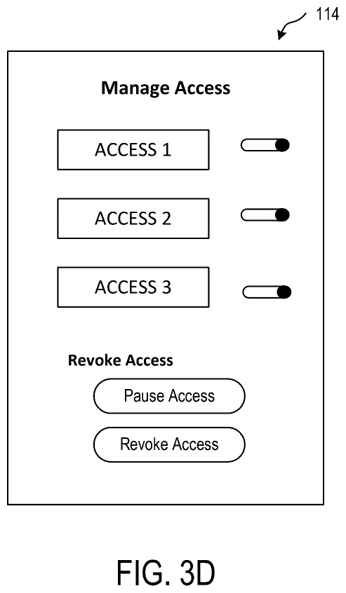

The identity pass system 110 may include one or more processing circuits/systems including one or more processors (e.g., ASICs, other processor types described herein) and associated memory devices. The one or more processing systems may be configured to perform various functions of the identity pass system 110. In general, at least one (e.g., each) identity pass system 110 may be owned, operated, and/or managed by a provider (e.g., provider institution associated with provider computing system 170) and/or a merchant, such as a credit card issuer, a consultant, a retailer, a service provider, a business, a cash management company, and/or the like. In some arrangements, the identity pass system 110 may include a user interface 114 (shown in FIGS. 3-5). It should be understood that various arrangements may include more, fewer, or different systems than illustrated in FIG. 1, and all such modifications are contemplated within the scope of the present disclosure.

The identity pass system 110 may facilitate operations including creating an identity pass of a user, as well as creating an entity profile for an entity. In some arrangements, the identity pass system 110 may receive a request to create an identity pass for a user. The identity pass request may be initiated by a user, an institution, a third party, and the like. The identity pass request may be initiated for various purposes, such as submitting a form, or accessing a resource. The identity pass may include identity tokens relating to attributes associated with a user. The identity pass system 110 may receive attributes that help define and authenticate a user's identity, such as personal information (e.g., full name, user name/ID, email address, etc.), authentication credentials (e.g., a password, security questions, biometric data, etc.), demographic information (e.g., date of birth, phone number, etc.), address information, user roles (e.g., admin, guest, etc.) that dictate access levels within the identity pass system 110, permissions (e.g., specific rights associated with the user's role, read/write access, etc.), account preferences, authentication tokens, session information, external identity providers (e.g., social media accounts, federal identity information, etc.), device information, and compliance information. The identity pass system 110 may also receive a verifiable credential of the user, such as educational credentials (e.g., diplomas, degrees, transcripts), professional certifications/licenses, identity credentials (e.g., digital IDs, passports, etc.), employment credentials, health credentials (e.g., vaccination records, medical licenses, etc.), membership credentials (e.g., professional memberships, club memberships, etc.), age verification, digital wallets (e.g., cryptocurrency wallets, etc.), and travel credentials.

The identity pass system 110 may generate an identity token by defining which attributes (e.g., claims) will be included in the identity token, such as an email address, role/permissions, issued timestamp, and the like. The identity pass system 110 may determine which claims to include based on a user's information and application requirements. The identity pass system 110 may then select a format for the token (e.g., JSON Web Tokens, etc.) and create token components (e.g., a header, a payload, a signature etc.) The identity token may include a header containing metadata about the token, such as the type of token, the cryptographic algorithm used to sign the token (e.g., HS256, RS256, etc.). The identity token may include a payload containing claims about the user and/or subject of the token. The claims may include registered/standard claims (e.g., unique identifier for the user, timestamp of when the token was issued, timestamp indicating when the token expires, recipient of the token, principal that issued the token, etc.), public claims (e.g., full name, email address, user roles, specific permissions granted, etc.), and private claims (e.g., custom claims created for specific use cases within an application that are not registered or public, etc. The identity token may include a signature generated to ensure the integrity and authenticity of the token. The signature may be created by taking the encoded header and payload, concatenating the encoded header and payload with a period, and signing them using the specified algorithm and a special key. The identity pass system 110 may encode the token components into a single string, generating an identity token. The generated identity token may be stored in a data storage, a memory, local storage cookie, server, cache, and the like. The identity pass may also include verifiable credentials of a user.

The identity pass system 110 may facilitate operations including fulfilling a request from the request computing system 150. The identity pass system 110 may access a data storage (e.g., relational databases, non-relational databases, data warehouses, file storage systems, cloud-based storage systems), such as the identity pass database 120, to fulfill the request. Accessing the data storage may include querying (e.g., receiving specific information from a database or other data repositories using queries), etc. for specific information associated with the user. The query may be a request for data or information from the data storage, and may be implemented via various methods and structures. The identity pass system 110 may query for unprotected information of a user that has been determined to be acceptable to transmit, or provide access to. Limiting the types and amount of information shared from the identity pass system 110 may provide improved control of the security and privacy of user data.

The identity pass system 110 may determine a first subset of the attributes corresponding with protected information of the user and a second subset of the attributes corresponding with the unprotected information of the user. In some arrangements, protected information may be information that is generally considered sensitive and/or legally protected by regulations, (e.g., data privacy regulations. Protected information may include personal identifiable information (e.g., social security number, phone number, etc.), health information (e.g., medical records, disability status, etc.), financial information (e.g., credit card numbers, bank account details, tax information, credit history, etc.), biometric data (e.g., fingerprints, facial recognition data, iris scans, voiceprints, etc.), location data (e.g., GPS coordinates, IP addresses, travel history, etc.), and the like. Unprotected information may include publicly available data, preferences, usage data, non-identifiable meta data, and the like. In some arrangements, the identity pass system 110 may determine that information is protected information based at least on user-defined criteria, or criteria defined by an institution or a third-party. In some arrangements, the identity pass system 110 may determine that information that is required to fulfill a request is unprotected, and that all other information is protected. The identity pass system 110 may share, or provide access to, only a portion of user attribute data that is determined to be unprotected. The identity pass system 110 may provide selective disclosure, allowing users to share specific attributes from their identity pass without revealing all attributes.

In some arrangements, the identity pass system 110 may be a network-enabled user-interactive device. In some arrangements, the data acquisition engine 180 may be excluded and/or included within identity pass system 110 itself. In some other arrangements, the identity pass system 110 may not contain a network circuit and may not be network-enabled (e.g., the identity pass system 110 may include short-range protocol, such as NFC, Bluetooth, etc.). Being networked, the identity pass system 110 may communicate over the network with the provider computing system 170 and/or user mobile device (e.g., the user devices 140).

The user interface 114 may be configured to generate and provide one or more graphical user interfaces (GUIs) for presentation on a display screen of an identity pass system 110. That is, the provided GUIs may execute and/or be displayed on a display on the identity pass system 110. In some arrangements, the GUI includes a visual representation of the identity pass that a user may interact with. In some arrangements, the GUIs may be provided within a web browser or a mobile application 142. As mentioned above, the GUIs may be provided as one or more interactable user interfaces. In another arrangement, the GUIs are generated and transmitted to the mobile application 142 for accessing by the user.

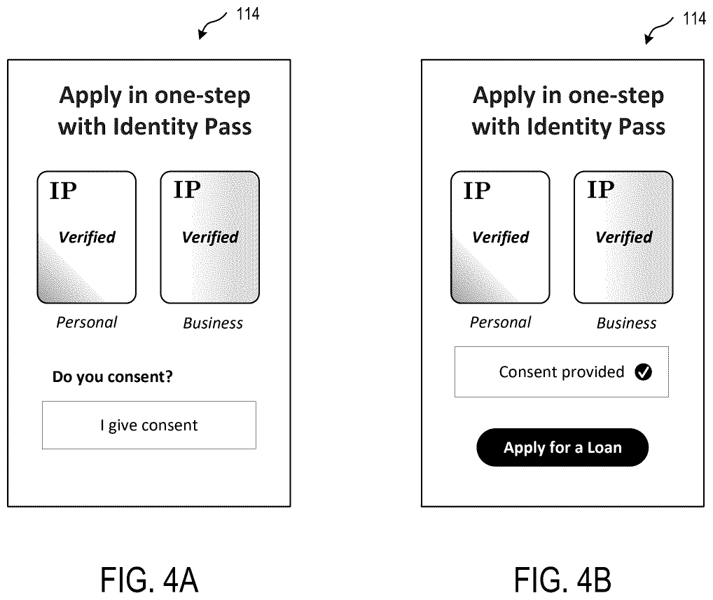

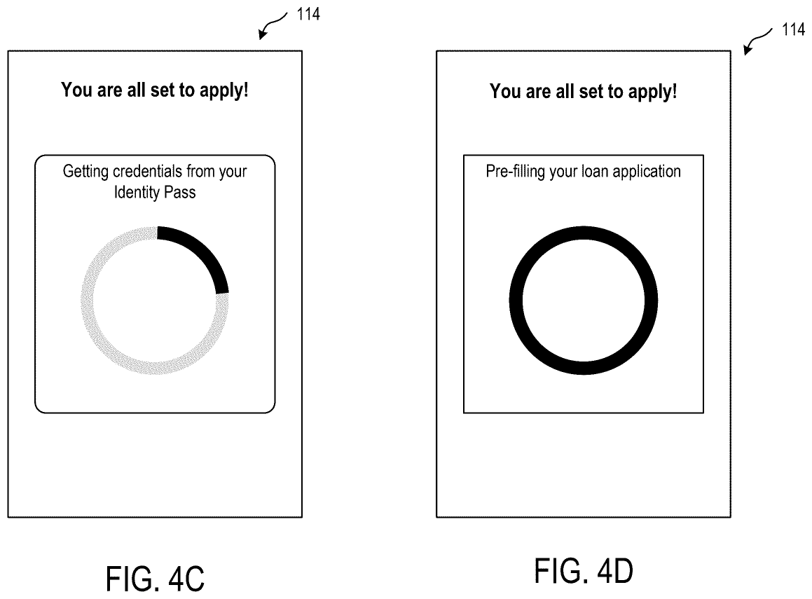

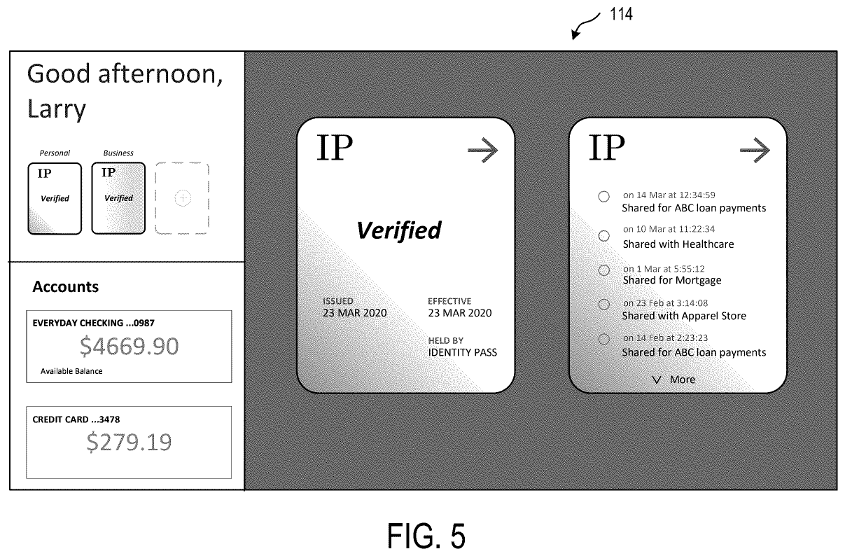

The GUI presented on the user interface 114 may include a plurality of interactive elements associated with the identity pass system 110, the request computing system 150, and the provider computing system 170. The identity pass system 110 may include instructions (e.g., scripts, executable code, etc.) that when executed by a processing circuit cause one or more GUIs to present on the display interface described herein. As mentioned above, the GUIs may be provided as one or more an interactable web pages. In another arrangement, the GUIs are generated and packaged into a mobile application accessible to a user (e.g., marketplace interface). Additional details relating to the user interface 114 are described in detail with reference to FIGS. 3A-3C, FIGS. 4A-D, and FIG. 5.

In some arrangements, the identity pass system 110 may be communicably coupled to an identity pass database 120. The identity pass database 120 may be structured as a repository (e.g., computer storage system such as one or more memory devices, etc.) that stores various data regarding users. The identity pass database 120 may be configured to store identity passes. In some arrangements, identity passes are stored on a distributed ledger. The distributed ledger may be a semi-private distributed ledger allowing selective access to the distributed ledger. That is, access to the distributed ledger may be restricted to a defined group of participants (e.g., institutions, organizations, groups, etc.), and allows only authorized participants to access and interact with the ledger. The identity pass database 120 may store user data (e.g., names, addresses, phone numbers, identifier, and so on), authentication information of customers (e.g., username/password combinations, device authentication tokens, security question answers, unique client identifiers, biometric data, geographic data, social media data, and so on), financial information of customers (e.g., token information, account numbers, account balances, available credit, credit history), and the like.

In various arrangements, some of the data may be encrypted by an encryption operation utilizing a cryptographic function. For example, the cryptographic function may be a homomorphic encryption function. In other example, the cryptographic function may be any symmetric encryption function (e.g., Triple Data Encryption Standard (TDES), RC5, Advanced Encryption Standard (AES), Blowfish, CAST, and so on), and/or asymmetric encryption function (e.g. Rivest-Shamir-Adleman (RSA), Efficient and Compact Subgroup Trace Representation (ECSTR or XTR), Digital Secure, Escrowed Encryption Standard (EES), and so on).

The identity pass database 120 may be accessed using one or more memory addresses or index values. The identity pass database 120 may be accessed by the components of the one or more processing circuits described herein (e.g., identity pass system 110, or any other system and/or devices described herein via the data acquisition engine 180) via the network 130. That is, the identity pass database 120 may be in communication with one or more processing circuits of the identity pass system 110, request computing system 150, and/or provider computing systems 170 via a private communication (sometimes referred to herein as a “secure connection”), in that one or more datasets stored in the identity pass database 120. In this regard and as described herein, the provider computing system 170 may maintain the identity pass database 120 in some arrangements.

It should be understood that identity pass database 120 may exist external to the identity pass system 110 and may be accessed via a communication network (e.g., network 130). The identity pass database 120 may be distributed across many different computer systems or storage elements and may be accessed via the communication network or a suitable computer bus interface. The one or more processing circuits of the identity pass system 110 may store, in the identity pass database 120, the results of any or all computations, determinations, encryptions, decryptions, selections, identifications, generations, constructions, or calculations in one or more data structures indexed with appropriate values, at least one (e.g., each) of which may be accessed by the one or more processing circuits of the identity pass system 110 to perform any of the functionalities or functions described herein. In various arrangements, the identity pass database 120 includes various transitory and/or non-transitory storage mediums. The storage mediums may include but are not limited to magnetic storage, optical storage, flash storage, RAM, and so on. The one or more processing circuits may use various APIs to perform database functions (e.g., managing data stored in the identity pass database 120). The APIs may be but are not limited to SQL, NoSQL, NewSQL, ODBC, JDBC, and so on.

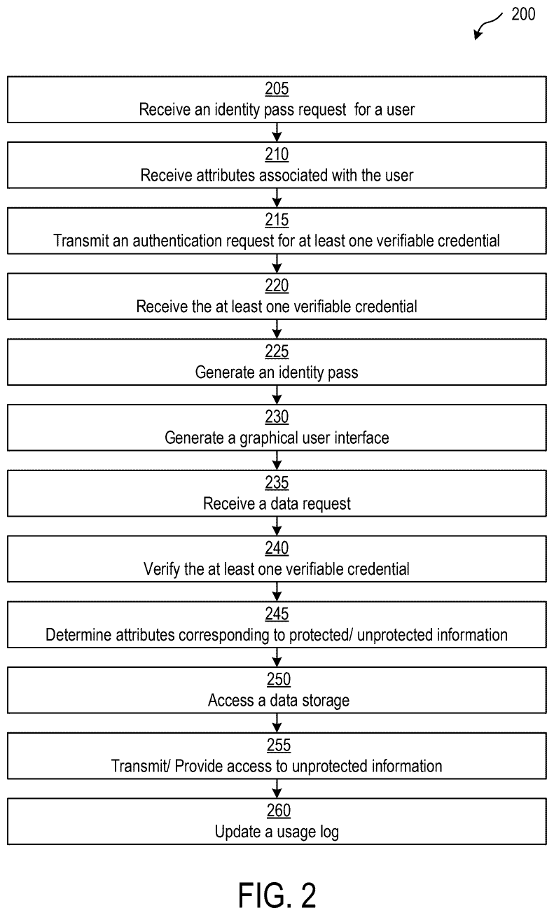

Referring now to FIG. 2, a flowchart for a method 200 of generating an identity pass that may be implemented or performed by one or more components of FIG. 1 is shown, according to one arrangement. The method 200 may be performed by a processor, such as an at least one processor of the identity pass system 10. Additional, fewer, or different operations may be performed depending on the particular arrangement. In some arrangements, some, or all operations of method 200 may be performed by one or more processors executing on one or more computing devices, systems, or servers. In some arrangements, each operation may be re-ordered, added, removed, or repeated. Additionally, some or all of the operations performed by the blocks may be removed or added.

At block 205, the processor may receive an identity pass request for a user. That is, the processor may receive a signal (e.g., command, instruction, etc.) to create an identity pass for a user. For example, a user may wish to create an identity pass to manage their credentials and facilitate identity verification and/or user information sharing. In another example, a user may open an account with a financial institution and wish to create an identity pass for more convenient usage of various financial services offered by the financial institution. An example of a user interface in which a user consents to providing access to credentials to create an identity pass and selects an action button to initiate the creation of the identity pass is shown in FIGS. 3A-3C, discussed further below. For example, the identity pass request may be automatically generated in response to an action, such as a user action, or as an account being formed. Additionally, the processor may receive an identity pass request for a user from more than one source, or from a single source, such as a financial institution.

That is, at block 205, the processor may validate the incoming request and determine the source of the request, such as a user device, a financial institution system, or an external third party. For example, the request may be triggered by the user initiating an action like opening a bank account, or it may be generated by an external system as part of an automated process. The request may include various types of data related to user identity, such as personal information or verification data, and may be handled by multiple systems operating in conjunction, such as the identity pass system 110 and external data sources. In some arrangements, the processor may queue requests for batch processing, ensuring system scalability and efficient handling of large numbers of identity pass creation requests.

In some arrangements, the entity profile request may be initiated by a user through a user action (e.g., user interactions with an application), or the identity pass request may be initiated by an institution (e.g., a financial institution) or third-party. Or, in some arrangements, the identity pass request may be generated responsive to a specific action or process (e.g., an onboarding process, a bank account application, loan application, patient registration, account creation, system access, wallet setup, policy applications, claims processing, etc.). Additionally, receiving may include the processor retrieving, fetching, accepting, storing, continuously monitoring, or sporadically monitoring for an identity pass request from a number of sources. Further, receiving the entity profile request may include the processor validating the request (e.g., authenticating, ensuring authorization/necessary permission to make the request, ensuring the data request may be in a valid format, etc.), processing the request, and/or logging the request (ex. recording details such as timestamp, requestor information, action taken, errors, etc.),

At block 210, the processor may receive at least attributes associated with the user. That is, the processor may receive data including identifying information associated with a user, such as information provided by the user, information pulled from databases or other data sources (e.g., the data sources 160), public available user information, private user information, or information associated with an account of the user. For example, attributes may include name, age, sex, date of birth, nationality, contact information, job, credit score, bank account information, and the like. In another example, the attributes may be provided by forms or records previously provided by the user.

That is, at block 210, method 200 may include the processor gathering user attributes required for creating the identity pass. The attributes may include personal details, verification data, and user preferences, which are retrieved from internal and external sources. For example, the processor may communicate with a database or data source 160 to retrieve information such as a user's name, address, or financial credentials. Additionally, in some arrangements, the system may use APIs to pull data from third-party systems, such as healthcare providers or government agencies, to verify the user's identity. The data gathered may be verified through multiple authentication steps, ensuring accuracy and integrity. For instance, the processor may perform cross-checks between the identity pass database 120 and external repositories to ensure the gathered data is consistent with existing records. Furthermore, in some cases, the processor may request user consent before retrieving certain types of data, especially when sensitive information, such as biometric or financial data, is involved.

In some arrangements, the attributes may be attributes selected by a user or an institution, or, the attributes may be selected by the processor based at least on criteria. The criteria may vary based at least on application, or may vary based at least on the specific user. Additionally, receiving may include the processor receiving data from input devices, (e.g., keyboards, mice, touch screens, etc.). Further, receiving may include the processor retrieving, fetching, or pulling attributes from available data, or, the processor may receive attributes in response to user consent (for example, as shown in FIG. 3A).

At block 215, the processor may transmit an authentication request for at least one verifiable credential of the user, and at block 220 the processor may receive the at least one verifiable credential of the user. That is, the processor may send a request to verify the identity of a user by requesting a verifiable credential. For example, the authentication request may be transmitted to a data source (e.g., data source 160, etc.) to obtain a verifiable credential. In another example, the processor may transmit the authentication request in response to user initiation/input.

That is, at block 215, the processor may transmit an authentication request to verify the identity of the user. This request may be sent to external systems or databases that store credentials or certificates necessary to verify the user's identity. For example, the processor may send a request to a government database to authenticate a user's passport information or to a financial institution to confirm banking details. In some arrangements, the processor may use cryptographic protocols to secure the authentication request, such as generating a unique session key or utilizing secure transmission protocols like HTTPS or TLS. Once the request is transmitted, the processor waits for a response, which may contain either a positive confirmation of the user's identity or an indication of an issue with the verification process. The processor may handle multiple authentication requests concurrently, using parallel processing techniques to improve system efficiency. For example, in cases where a user is applying for multiple services at once, the processor may batch the authentication requests and transmit them simultaneously to reduce latency.

That is, at block 220, the processor may receive the authentication credentials in response to the request sent at block 215. The returned credentials may be in the form of digital certificates, cryptographic tokens, or other forms of verifiable credentials. For example, the system may receive a JSON Web Token (JWT) containing the necessary authentication data for the user, signed by the issuing authority. In some arrangements, the processor may validate the received credentials by checking the integrity of the digital signature using cryptographic techniques, such as RSA or ECC (Elliptic Curve Cryptography). Additionally, the processor may validate the expiration date of the credentials and ensure that the certificate chain of trust is intact. If any part of the credential verification process fails, the processor may flag the issue, logging it in the system for future reference or triggering a retry mechanism to request updated credentials. In other cases, the processor may store the valid credentials in the identity pass database 120 for future use, ensuring that the system may respond to future requests for verification without the need to re-authenticate the user each time.

In some arrangements, the verifiable credential may include a cryptographic signature created by an issuer (e.g., the entity that issued the credential) of the verifiable credential. The verifiable credential may be signed using a private key to ensure that the credential may be verified by anyone with access to the issuer's public key. The processor may receive metadata about the issuer, including the public key, which may be provided in the form of a digital certificate. The public key of the issuer may be extracted from the verifiable credential, and may be retrieved from a trusted source or included in the verifiable credential. The public key may be used to decrypt a digital signature attached to the credential and confirm the authenticity of the verifiable credential. In some arrangements, cryptographic operations may be performed to generate a cryptographic object (or cryptographic output) from the verifiable credential to verify the verifiable credential. Cryptographic operations may include encryption/description (e.g., symmetric encryption such as advanced encryption standard (AES), asymmetric encryptions, etc.), hashing (e.g., SHA-256), digital signatures, key change, message authentication codes, cryptographic random number generation, and the like. In some arrangements, the user may provide the cryptographic object for the verifiable credential.

In some arrangements, the verifiable credential may be an educational credential, a professional credential, an identity credential, a health credential, a financial credential, an age verification credential, and the like. Additionally, transmitting may include the processor sending the authentication request to a data source that may be associated with the entity that manages, or generates the verifiable credential. For example, the authentication request may be transmitted to the user, a government entity, or third-party.

At block 225, the processor may generate an identity pass including a set of identity tokens and the at least one verifiable credential. The set of identity tokens includes at least a first identity token including attributes of the user. That is, the processor tokenizes the attributes of the user, and the resulting identity token becomes part of the created identity pass. The processor may generate identity tokens in accordance with a token or a control structure. The processor further includes the at least one verifiable credential in the identity pass. In another example, the identity pass may include a driver's license as the at least one verifiable credential in the identity pass. Additionally, the processor may update the identity pass as additional data relating to the user becomes available, or, if data relating to the user changes (e.g., a credit score may be updated, an account balance increases, etc.).

That is, at block 225, the processor generates the identity pass by creating one or more identity tokens, which may include attributes and credentials associated with the user. In some arrangements, these tokens may be structured according to predefined token formats, such as JWT or XML-based tokens, and may include attributes like a user's email, phone number, or biometric identifiers. The processor may digitally sign the identity tokens to ensure their integrity and store them securely in the identity pass database 120. For example, the tokens may be encrypted using symmetric encryption algorithms such as AES or Triple DES before being stored. In some arrangements, the identity pass may be updated dynamically if new information becomes available, such as when the user updates their credentials or when the system receives additional verification data. Additionally, the identity tokens may be shared with external systems upon request, allowing those systems to verify the user's identity based on the signed and authenticated data contained within the tokens. The processor may also implement access controls, ensuring that only authorized systems or entities may access the tokens or request updates to the identity pass.

In some arrangements, the first identity token including attributes of the user may be generated by the processor by first hashing user data, including the attributes. The processor may then generate a token, which may include a unique identifier, the hashed data, a timestamp, and/or any other attributes related to the user. Further, the token may be encrypted (e.g., using symmetric or asymmetric encryption methods), and the token may be signed with a private key to verify authenticity. The generated token may then be stored. In addition, generating the identity pass may include the processor analyzing the attributes and/or other user information from data sources in order to generate the identity tokens.

In some arrangements, the method 200 may include the processor generating a second identity token of the set of identity tokens including access credentials corresponding to the exchange instrument. That is, the processor may generate credentials that verify a user's identity and grants access to various systems, application, or data. For example, access credentials may include usernames and passwords, access codes, security tokens, digital certificates, and the like.

At block 230, the processor may generate a GUI including a representation of the identity pass. The identity pass includes one or more interactive elements. Selection of the one or more interactive elements includes updating the representation corresponding with the identity pass. That is, the processor may create a representation that encompasses the way the identity pass is visually and/or functionally depicted and/or structured for users via a user interface. The processor may start an application and create a main window depicting the identity pass and may design a visual representation of the identity pass. Generating a representation may include rendering a visual representation of the identity pass. For example, the visual representation of the identity pass may include a display area where a depiction of a card/pass to represent the identity pass is rendered, text elements, and/or image elements. The processor may design and/or render, for example, a dashboard, an activity log, menu, a window, a screen, a landing page, and the like. The processor may apply styles (e.g., colors, fonts, spacing, borders, background patterns, images), branding elements (e.g., logos, design themes, etc.), security features, and the like.

That is, at block 230, the processor may generate a graphical user interface (GUI) to display the identity pass and associated data. In some arrangements, the GUI may include interactive elements that allow the user to view and manage their identity pass. For example, the interface may display a virtual card representing the user's identity pass, which may include details such as the issuance date, expiration date, and status of the identity pass (e.g., “Verified” or “Pending Verification”). The processor may create this visual representation using rendering techniques that support various device types, such as mobile phones, tablets, or desktop computers. Additionally, the processor may generate a dynamic interface where the user may interact with elements such as toggling access permissions for third parties, updating their personal information, or requesting additional verifiable credentials. The user interface 114 may communicate directly with the identity pass system 110, and the processor may manage real-time updates to reflect any changes to the user's credentials or verification status. In another example, the user may interact with buttons to consent to share specific credentials, such as during a loan application process. The interface may also include progress indicators, showing users the status of pending actions such as credential verification or updates.

The processor may generate user input elements such as buttons, icons, menus, text fields, checkboxes, and the like, for a user to interact with. A user may select the interactive element by clicking a text box, typing data into a text input field, clicking a dropdown menu, clicking a radio button, clicking a checkbox, dragging a slider, clicking a button to trigger an action, selecting a file to upload, clicking a toggle switch, and the like. For example, a user may navigate to a page in an identity pass management application and click through a menu to navigate to a page requesting a new service. The user may click a button to consent to providing access to the identity pass to a new entity for the new service. The user's selection may trigger an update to a usage log for the identity pass by creating a new entry in the usage log. The usage log may depict a record of activity relating to the identity pass. In some arrangements, a visual representation of the identity is created that resembles a physical card, or pass. One side of the visual representation may include basic information relating to the identity pass, such as issue date, expiration date, and identity pass issuer. A user may select the visual representation to flip or otherwise rotate the visual representation to display an opposite side of the visual representation to present additional information relating to the identity pass, such as a usage log. Examples of GUIs are discussed in detail below with reference to FIGS. 3A-3D, FIGS. 4A-4D, and FIG. 5.

In some arrangements, the GUI displayed may present a notification to a user providing a summary of a transaction. The summary may indicate a summary of the payment (e.g., amount, identity of the receiving party, etc.) Additionally, updating the representation may include presenting a usage log. The usage log may provide records of all transactions/interactions with the identity pass, including specific details relating to the transaction/interaction such as a timestamp, what was shared, and who information was shared with.

At block 235, the processor may receive a data request corresponding with the at least one verifiable credential or at least one of the set of identity tokens of the identity pass. The data request may be for an exchange using an exchange instrument, by the user, or providing at least one of the attributes of the user. That is, data associated with a verifiable credential or identity token of the identity pass may be requested to execute an action, The processor may process the request. For example, the data request may be initiated to complete a transaction, or to fill out a form, or otherwise verify the identity of the user. In another example, the user may select an option to provide access to the identity pass via an application on their user device. In response to the user input, a data request may be transmitted to the processor. Additionally, the data request may be transmitted for a variety of applications, such as user identification, service personalization, account management, transaction processing, regulatory compliance security measures, service improvement, and the like.

That is, at block 235, the processor may receive a data request from an external system, which may correspond to at least one verifiable credential or identity token stored in the user's identity pass. For example, a financial institution's system may send a request for a user's employment verification as part of a loan approval process. In response to the data request, the processor may identify the relevant identity tokens or credentials from the identity pass and prepare them for transmission. In some arrangements, the processor may prompt the user for consent before sharing any data, particularly for sensitive or protected information. Additionally, the request may specify certain attributes needed, and the processor may determine whether the requested information is protected (e.g., social security number, bank account details) or unprotected (e.g., user name, job title). If the information is protected, the processor may restrict access based on predefined policies or request further authentication before sharing the information. Furthermore, the processor may log the data request and corresponding actions, creating an audit trail to ensure that all data exchanges comply with security and privacy requirements.

In some arrangements, the data request may include requestor information, a purpose of the request, the type of data requested, a time frame, and/or an indication of whether the data may be sensitive. Additionally, receiving the data request may include the processor providing a notification to elicit a user input from the user to accept or deny the data request. The processor may then initiate the transmittal of the data request. In some arrangements, the data request may be initiated with user input (e.g., via a user device) and then transmitted to the processor.

In some arrangements, the method 200 includes the processor verifying, using at least one authentication protocol, the data request. The processor then transmits, to a computing system, the at least one set of identity tokens. That is, prior to transmitting an identity token to a computing system, the processor verifies the data request by validating/confirming an identity of the requestor. For example, when a request to access data may be received, the processor may check for valid credentials, and grant or deny access based at least on the validity. In some arrangements, the authentication protocol may be a password-based authentication, a token-based authentication, multi-factor authentication, challenge-response authentication, public key infrastructure, and the like.

At block 240, the processor may verify the at least one verifiable credential based at least on verifying a cryptographic object (e.g., a public key, symmetric/asymmetric keys, digital certificates, hash values, digital signatures, tokens, secure enclaves, randomly generated numbers, cryptographic algorithms, etc.), an issuer, or a status of the at least one verifiable credential. That is, the processor may ensure the authenticity, integrity, and validity of the at least one verifiable credential obtained via the authentication request. For example, the processor may retrieve the verifiable credential, validate the structure by checking that the verifiable credential conforms to an expected format (e.g., correct fields and types), check the issuer's signature (e.g., using a public key,), ensure that the verifiable credential is not expired, and/or check that the verifiable credential has not been revoked. In another example, the processor may verify the at least one verifiable credential by assessing the accuracy of the claims within the verifiable credential.

That is, at block 240, the processor may verify the at least one verifiable credential using cryptographic techniques or other validation methods. This step is crucial to ensuring that the data shared with external systems is accurate and has not been tampered with. For example, if the verifiable credential is signed using a cryptographic key, the processor may check the signature against a trusted key stored in a key management system. The processor may also validate the credential's expiration date, issuer, and overall structure to ensure that it complies with expected formats, such as JSON Web Tokens (JWT) or X.509 certificates. In some arrangements, the processor may perform additional checks, such as comparing the credential against a certificate revocation list (CRL) to ensure that it has not been revoked by the issuing authority. If the verification process fails at any point, the processor may return an error message to the requesting system or take corrective actions, such as requesting updated credentials. In another example, the processor may hash the credential's contents and compare it to a previously stored hash to verify that no alterations have occurred since it was issued.

Generally, verifying the cryptographic object may include various verification processes, and generally include hashing, public key operations, and integrity checks. Verifying the verifiable credential may include verifying digital signatures by obtaining the associated data and digital signature, hashing the data by applying the same hash function used by the issuer to generate a hash value, decrypting the signature using the issuer's public key to obtain the original hash value created by the issuer, and comparing the hash values. Verifying the cryptographic object may also include verifying digital certificates, by checking a certificate chain, validating a signature using a public key of the issuer, and checking revocation status (e.g., verifying that the certificate has not been revoked by consulting a certificate revocation list or using an online certificate status protocol, and checking a validity period. Further, verifying the cryptographic object may include verifying tokens and include the processor decoding a received token, verifying the token signature using the issuer's public key, and verifying claims such as expiration time, issuer, and recipient.

In some arrangements, the public key may be retrieved by the processor from a decentralized identifier document or a trusted registry. The processor may use the public key to verify the digital signature attached to the verifiable credential, ensuring that the verifiable credential was issued by the claimed issuer, and the contents of the verifiable credential have not been altered since it was issued. In some arrangements, public keys may be encoded in specific formats for storage and transmission, typically, as strings of characters, including letters, numbers, and special characters. In some arrangements, public keys may be derived from mathematical algorithms and represented as large numbers or points on an elliptic curve. Additionally, public keys may have different lengths and complexity to ensure security.

For example, using an RSA encryption, the verifiable credential may be encrypted and/or hashed by the issuer of the verifiable credential such that the verifiable credential may be considered signed. The processor may calculate a hash of the verifiable credential, and decrypt the verifiable credential using the public key to produce a hash. If the two hashes are identical the processor may verify the verifiable credential was signed by the central provider and that it was not changed or tampered with. Alternatively, if the two hashes do not match, the verifiable credential is not the verifiable credential sent by the issuer (e.g., it was changed or tampered with). In various arrangements, instead of using RSA encryption, the digital assets may be signed and verified using AES encryption, SHA encryption, DES encryption, and so on. All communications may be encrypted with one or more secure network protocols (e.g., Secure Shell (SSL), Kerberos, IPSec, Secure Sockets Layer (SSL), Hypertext Transfer Protocol Secure (HTTPS), etc.) implemented utilizing a cryptographic function (e.g., symmetric encryption, asymmetric encryption, hashing, etc.). In some examples, the cryptographic function may be a homomorphic encryption function. In some examples, the cryptographic function may be any symmetric encryption function (e.g., Triple Data Encryption Standard (TDES), RC5, AES, Blowfish, CAST, etc.), and/or asymmetric encryption function (e.g., RSA, Efficient and Compact Subgroup Trace Representation (ECSTR or XTR), Digital Secure, Escrowed Encryption Standard (EES), etc.).

Additionally, the processor may ensure that the verifiable credential may be being used in an appropriate context (e.g., academic credentials being used in an educational application) and/or ensure that the user may be the subject of the verifiable credential. In some arrangements, the processor may log verification attempts, recording details such as time of verification, results, and any errors encountered, in order to provide records for audits and/or review. Further, if the verifiable credential cannot be verified, the processor may provide a notification indicating an issue with verification.

At block 245, the processor may, responsive to verifying the at least one verifiable credential, determine, based at least on the data request, a first subset of the attributes corresponding with protected information of the user and a second subset of the attributes corresponding with unprotected information of the user. That is, the processor may determine (e.g., identify, classify, group, categorize, assess, analyze, sort, etc.) whether attribute information in the identity pass may be protected and unprotected based at least on data being requested. For example, the processor may determine that protected information may be information that is not required and/or relevant to satisfy the data request, and that unprotected information may be required to satisfy the data request. The subset of attributes corresponding with unprotected information of the user may be data that may be identified in the data request. For example, a data request may require identifying information such as a name, address, and age. However, the request may not require a user's social security number. The processor may determine that the name, address, and age are unprotected information whereas the social security number may be protected information. In another example, the processor may determine that protected information may be information that confidential, restricted,, or sensitive. The processor may determine that unprotected information may be information that may be non-confidential, publicly available, or user consented. Additionally, the processor may determine that information may be unprotected based at least on specific predefined criteria provided by the user, an instruction, or third-party. The predefined criteria may include specific characteristics or features of the data, tags/labels, classifications, and/or definitions. Further, the processor may apply predefined rules to determine if the attributes are unprotected or protected.

That is, at block 245, the processor may determine the protected and unprotected information within the user's identity pass based on the data request received. In some arrangements, the processor may categorize the attributes contained in the identity pass into protected information, which is sensitive or legally restricted, and unprotected information, which may be shared more freely. For example, protected information may include biometric data, social security numbers, or credit card details, while unprotected information may consist of user names, general location data, or public credentials. The processor may apply predefined rules or use machine learning models trained on labeled datasets to classify the data. In some arrangements, the processor may allow the user to define what data is considered protected, giving them control over how their identity pass is used. Additionally, the processor may log each determination, recording why certain data was classified as protected or unprotected. This log may be used for auditing purposes or to ensure compliance with data privacy regulations. For example, the system may need to comply with GDPR, where protected information is only shared after explicit user consent.

In some arrangements, protected information may include personal identifiable information (e.g., security number, financial information (e.g., bank account number, credit card details, payment information), health information (e.g., medical records), biometric data (e.g., fingerprints, facial recognition), confidential communication, and the like. In some arrangements, unprotected may include public social media profiles, job titles, public records, non-sensitive demographic information such as general location, or marketing data. Additionally, determining may include the processor processing the data request to identify attributes that need to be retrieved to satisfy the request. The processor may apply a predetermined rule (e.g., if-else conditions) in which required information may be classified as unprotected, otherwise the information may be classified as protected. Additionally, the processor may use machine learning algorithms trained on labeled datasets to classify data. Further, determining may include the processor assigning information to a group and/or tagging the information, as well as maintaining a log of the determination.

At block 250, the processor may access a data storage storing the identity pass. Accessing the data storage includes querying for unprotected information of the user corresponding with the at least one of the set of identity tokens. The query returns the unprotected information to satisfy the exchange or permit access to at least one of the attributes of the user. That is, the processor may communicate with a data storage to obtain requested user information, and request specific unprotected information relating to an identity token from the data storage based at least on criteria associated with satisfying data request. The processor may utilize queries (e.g., requests for information/data) to access, manipulate, or analyze data based on specific criteria. The processor may utilize queries (e.g., database queries, search queries, API queries, etc.) to return desired results. The processor may receive or formulate a query to retrieve the requested data, send the query to the data storage, execute the query by accessing (e.g., reading data, applying filters, joins, aggregations, or calculations, etc.) the necessary data, and retrieve the data. In some arrangements, the processor may formulate a query based on user input or application logic. For example, the processor may access a data storage and seek information relating to filling out a loan application. The processor will not return information that is not relevant to the data request, and therefore will not share protected information when not needed. In some arrangements, a processor of the data storage may receive the query, execute the query, and return results to the processor.

That is, at block 250, the processor may access the data storage that holds the identity pass and retrieve the unprotected information needed to satisfy the data request. The retrieval process may involve querying the identity pass database 120 or any other associated data storage systems. In some arrangements, the processor may use an SQL query or a NoSQL approach, depending on how the data is structured. For example, the processor may query for attributes such as the user's job title, which may be required for employment verification during a mortgage application. If the request pertains to multiple attributes, the processor may filter out any protected data, ensuring that only unprotected information is shared with the requesting system. In another example, the processor may query a distributed ledger, such as a blockchain-based storage, to retrieve immutable records associated with the user's identity pass. Additionally, the processor may apply specific rules to minimize the amount of data shared by only transmitting the information that is strictly necessary to satisfy the request. The processor may also check for any applicable time-based access rules, such as limiting access to certain data for a specific duration.

In some arrangements, the data storage is a distributed ledger. The distributed ledger may be a semi-private distributed ledger allowing selective access to the distributed ledger. Additionally, accessing the data storage may include the processor generating a request for data, using a data bus to communicate with the data storage, retrieving data, transferring data, and processing the retrieved data. In some arrangements, the data storage may be a cloud storage, network attached storage, database storage, hybrid storage, and the like. Additionally, when the query returns unprotected information, the processor may determine, based at least on the data request, a portion of the unprotected information to satisfy the request. The processor may then provide the least amount of information required to satisfy the request and reduce sharing of user information. In some arrangements, the data storage may be a distributed ledger database and/or blockchain.

At block 255, the processor may transmit, to a computing system, the unprotected information to satisfy the data request, or, permit access, to the computing system, to the unprotected information to satisfy the data request. That is, the processor may complete (e.g., satisfy, fill, execute, etc.) the data request by fetching/retrieving and/or identifying the required data from the data storage to be sent to the requestor. For example, the processor may transmit the unprotected information to populate corresponding data fields required for an application. In another example, the processor may provide permission to the computing system to access the unprotected information needed. That is, at block 255, the processor may transmit the retrieved unprotected information to the requesting system, completing the data request. In some arrangements, this may involve directly transmitting the data or granting time-limited access to the requesting system. For example, the processor may transmit the data securely using encryption protocols such as TLS or IPSec to ensure the integrity and confidentiality of the information during transmission. In another example, the processor may grant the requesting system a temporary access token that allows it to fetch the unprotected data within a specific time window. The processor may also implement additional security measures, such as applying data masking techniques, which may obfuscate sensitive parts of the information, or using tokenization methods to replace sensitive fields with non-sensitive equivalents. Additionally, the processor may update the usage log to reflect the transaction, capturing details such as the time of the request, the attributes shared, and the identity of the requesting system. This log may be crucial for auditing purposes and ensuring that all data exchanges are conducted within the framework of the user's consent and legal requirements.

That is, at block 255, the processor may transmit the retrieved unprotected information to the requesting system, completing the data request. In some arrangements, this may involve directly transmitting the data or granting time-limited access to the requesting system. For example, the processor may transmit the data securely using encryption protocols such as TLS or IPSec to ensure the integrity and confidentiality of the information during transmission. In another example, the processor may grant the requesting system a temporary access token that allows it to fetch the unprotected data within a specific time window. The processor may also implement additional security measures, such as applying data masking techniques, which may obfuscate sensitive parts of the information, or using tokenization methods to replace sensitive fields with non-sensitive equivalents. Additionally, the processor may update the usage log to reflect the transaction, capturing details such as the time of the request, the attributes shared, and the identity of the requesting system. This log may be crucial for auditing purposes and ensuring that all data exchanges are conducted within the framework of the user's consent and legal requirements.

In some arrangements, the processor may send the unprotected information directly (e.g., direct data transmission), or in a requested structured format. In some arrangements, the processor may grant access to data using various access control protocols, such as token-based access. Additionally, transmitting the unprotected data may include the processor encrypting or securing data (e.g., hashed, password protected, etc.) that may be shared and/or accessed to prevent unauthorized parties from performing unauthorized actions. For example, a masking algorithm may be executed performing bitwise operations (e.g., NOT, AND, NAND, OR, XOR, Complement, left-shift (logical or arithmetic), right-shift (logical or arithmetic), rotate right, rotate left, and so on) on any data that may be transferred. In some arrangements, the processor may grant access that may be time dependent to minimize exposure to sensitive information, or ensure that data access mechanisms. Further, access to the unprotected information may include the processor allowing a user to control and manage the access. For example, the user interface in FIG. 3D shows a menu allowing a user to manage access that has been granted. The user may revoke, or pause, access that has been provided.

At block 260, the processor may update a usage log of the identity pass corresponding with the data request. That is, the processor may update (e.g., add an entry to) a summary of transactions and/or interactions with the identity pass with information associated with the data request. For example, when a data request is processed, the processor may generate a new entry in the usage log with specific details (e.g., time of data request, time of access, what user information was shared, identity of requestor, etc.) of the data request. The entry may be structured in a consistent, structured format. Additionally, updates to the usage log may be triggered by specific actions, such as user actions, system events, or data request being received.

That is, at block 260, the processor may update the usage log with information corresponding to the data request. The log may include details such as what data was accessed, the requesting entity, and the time of the request. In some arrangements, the processor may also log whether the request was fulfilled successfully or if there were any errors during the process. For example, the log may show that a financial institution accessed a user's employment verification data for a loan application. The processor may store these logs in a secure audit trail, ensuring that all interactions with the identity pass are properly recorded for future reference. Additionally, the usage log may be updated to reflect when the user consents to share information, ensuring that all data requests are tied to explicit user permissions. In some arrangements, the usage log may be accessed by both the user and system administrators for review. For example, a user may review their activity log through the user interface 114 to see when their credentials were shared and with whom.

In some arrangements, updating the usage log of the identity pass includes updating the representation of the identity pass in the GUI. The representation of the identity may then reflect a current status of the identity pass. In some arrangements, the usage log may be accessed directly from a menu of a user device (e.g., in a mobile application). The usage log of an identity pass may be displayed when a user selects the identity pass in a menu. In some arrangements, further details of at least one (e.g., each) transaction may be accessed by selecting the corresponding entry in the usage log.

In some arrangements, the method 200 includes the processor further receiving a second data request for supplementary information associated with the user. Responsive to user approval, the processor receives the supplementary information. The processor then generates at least a second identity token of the set of identity tokens including the supplementary information and updates the identity pass based at least on the second identity token. That is, a request for information may be received, and a user may approve (e.g., verify, consent, accept, etc.) accessing this information. The information may be then received by the processor. For example, the supplementary information may be a tax history or a credit score. The processor may tokenize the supplementary information and update the identity pass. For example, a user may apply for a mortgage using their identity pass. However, the identity pass may not include information relating to a credit score. The processor may receive a request to obtain the user's credit score and execute the request to update the user's identity pass with the credit score. Additionally, the processor may receive a data request when updated information becomes available for a user, such as a user's credit score changing.

In some arrangements, the supplementary information may be user information that is not currently contained in the identity pass. For example, the supplementary information may be information that is not available based at least on any prior user-provided information, or, it may be private information (e.g., information that is not desirable to be public, sensitive information, information that may pose a security risk, etc.). The supplementary information may be, for example, tax history, or a credit score. In some arrangements, user approval may be user consent provided via a user interface (e.g., user interface 114). After obtaining user approval, the processor generates at least a second identity token of the identity tokens including the supplementary information and updates the identity pass based at least on the second identity token. In some arrangements, the processor verifies the data request using at least one authentication protocol, and transmits at least one of the set of tokens to a computing system (e.g., request computing system 150). In some arrangements, the processor generates an identity token of the set of identity tokens including access credentials corresponding to the exchange instrument.

In some arrangements, the method 200 includes updating the identity pass. That is, an identity pass of a user may be updated as data requests are received and executed by the processor. Thus, the identity pass may indicate any interactions relating to the identity pass. Additional, fewer, and/or different operations may be performed depending on the particular application. In some arrangements, the provider computing system 170 may also perform and/or perform tasks/processes in parallel with identity pass system 110.

Referring now to FIGS. 3A-3D, 4A-4D, and 5, example illustrations of the user interface 114 are depicted, according to some arrangements. The user interface 114 may be provided on a user device 140 and may include a plurality of interactive elements. Interactive elements (e.g., input fields, scroll elements, selectable icons, etc.) may include, but are not limited to, text input, buttons, icons, images, switch, drop-downs, speech-to-text, and so on. Furthermore, various interactive elements are contemplated in this disclosure. For example, a user may select an operation to perform.

Referring to FIGS. 3A-3D in more detail, user interfaces 114 displayable on a user device at several stages in the process of creating an identity pass are shown, according to an example arrangement. The user interfaces 114 may be displayed on a user device via a mobile application. FIG. 3A illustrates a starting screen for a user to initiate the creation of an identity pass. The user interface 114 illustrated in FIGS. 3A-3D may be launched on a mobile application of a user device when the user selects a an option to create an identity pass. The user interface 114 in FIG. 3A includes a visual representation of multiple identity passes that may be associated with a user. In the example shown, at least one (e.g., each) identity pass may be for a different application (e.g., different types, etc.), for instance, personal use, business use, and corporate use. The user may select a type of identity pass they wish to create. FIG. 3A shows a request for consent to access a user's ID credentials. The user interface 114 may provide an action for the user to select/consent whether to provide access to an identity pass. In FIG. 3A, the user may check a box to indicate consent to provide access to various identification credentials to create the identity pass. FIGS. 3B-3C depict a loading screen as an identity pass for a user may be created and a visual representation of the identity pass. FIG. 3D depicts an option for a user to manage access to the identity pass to various institutions, platforms, merchants and the like. In the example shown, a user may easily toggle access on and off, as well as permanent revoke access, or temporarily pause access.

Referring to FIG. 3B, the user interface 114 may present an interface showing the creation of an identity pass. The user interface 114 may include a progress indicator and the message “Creating your Identity Pass.” For example, the user interface 114 may display the identity pass as being “Verified” while the creation process progresses. In this example, the user interface 114 may update the progress indicator to reflect the ongoing status of the identity pass creation.

Referring to FIG. 3C, the user interface 114 may show the completion of the identity pass creation process. The user interface 114 may display the message “Done” to indicate the process has finished, along with a progress indicator showing completion. For example, the user interface 114 may display the verified identity pass as “Verified” and provide a message indicating that the user may access the identity pass in the profile section. In this example, the user interface 114 may remain in this state after the identity pass has been successfully created.

Referring to FIG. 3D, the user interface 114 may present an interface for managing access to the identity pass. The user interface 114 may display a list of access entries labeled “ACCESS 1,” “ACCESS 2,” and “ACCESS 3,” each with corresponding toggle switches for adjusting access settings. For example, the user interface 114 may include options to revoke access, with selectable buttons labeled “Pause Access” and “Revoke Access.” In this example, the user interface 114 may allow the user to manage which entities or systems have ongoing access to their identity pass by pausing or revoking access as necessary.

Referring to FIGS. 4A-4D in more detail, FIGS. 4A-4D depict a data request in the form of a loan application. In FIG. 4A-4D a user gives consent to provide access to their identity pass, and initiates a loan application process. The data request may be associated with various credentials in the identity pass. In FIGS. 4C-4D, credentials are pulled from the identity pass to pre-fill the loan application. Therefore, the user, in providing access to their identity pass, may fill out a loan application without entering in any information.

Referring to FIG. 4A, the user interface 114 may present an interface for the user to apply in one step with Identity Pass. The user interface 114 may include two sections marked as “Personal” and “Business,” both indicated as verified. For example, the user interface 114 may include a prompt asking, “Do you consent?” followed by a selectable option labeled “I give consent.” In this example, the user may select this option to provide the necessary consent for proceeding with the application process.

Referring to FIG. 4B, the user interface 114 may show the state after the user has provided consent. The user interface 114 may include an indication that “Consent provided” is checked. For example, the user interface 114 may further display the option to apply for a loan, which may be presented as a selectable button labeled “Apply for a Loan.” In this example, the user interface 114 may maintain the same verified identity pass options for “Personal” and “Business” as shown in FIG. 4A.

Referring to FIG. 4C, the user interface 114 may present a status indicator as the system retrieves credentials from the Identity Pass. The user interface 114 may include a message “Getting credentials from your Identity Pass” along with a visual loading indicator. For example, the user interface 114 may remain in this state while credentials are being retrieved. In this example, the status indicator in the user interface 114 may update to reflect progress during this operation.

Referring to FIG. 4D, the user interface 114 may present a status indicator as the system pre-fills the user's loan application. The user interface 114 may include a message “Pre-filling your loan application” along with a visual loading indicator. For example, the user interface 114 may remain in this state while the loan application is being populated with data from the Identity Pass. In this example, the progress indicator in the user interface 114 may show the advancement of the pre-filling process.

FIG. 5 shows a usage log, according to one arrangement. FIG. 5 shows a user profile page (a dashboard, an account page, main menu, etc.) in which the user may select an identity pass and obtain a usage log showing the date, time, and source, of data requests associated with the identity pass. The dashboard shown in FIG. 5 includes a visual representation of the identity pass having a front side with effective date, issues dates, and the like, and an opposite side with a usage/activity history. The usage log shows how and where user information may be shared. In some arrangements, the usage log may be updated by updating the representation of the identity pass in the GUI. The representation of the identity pass of the GUI may be updated by presenting the usage log. For example, new data requests and sharing of user information may add a new entry into the usage log.

Referring still to FIG. 5, the user interface 114 may present an interface displaying the user's identity pass and associated account information. The user interface 114 may display a personalized greeting, “Good afternoon, Larry,” along with a verified status of the identity pass. For example, the user interface 114 may include sections for “Personal” and “Business” identity passes, both marked as verified, and an overview of accounts including an everyday checking account with a balance of $4669.90 and a credit card with a balance of $279.19. In this example, the user interface 114 may provide a summary of active accounts linked to the identity pass.

The user interface 114 may further display the status of the identity pass as “Verified” with additional details such as the issue date, “23 Mar. 2020,” and effective date, “23 Mar. 2020.” For example, the identity pass may indicate that it is “Held by Identity Pass,” as shown in the center section of the user interface 114. In this example, the user interface 114 may present a detailed view of the identity pass status and its associated metadata.

The user interface 114 may further display a usage log detailing when and how the identity pass was shared. The user interface 114 may present individual entries such as “Shared for ABC loan payments on 14 MAR at 12:35:49” and “Shared with Healthcare on 10 MAR at 12:24:12.” For example, the user interface 114 may allow the user to view past interactions with the identity pass by selecting a button labeled “More” to expand the log and view additional entries. In this example, the user interface 114 may provide an interactive list showing the recent sharing history of the identity pass.

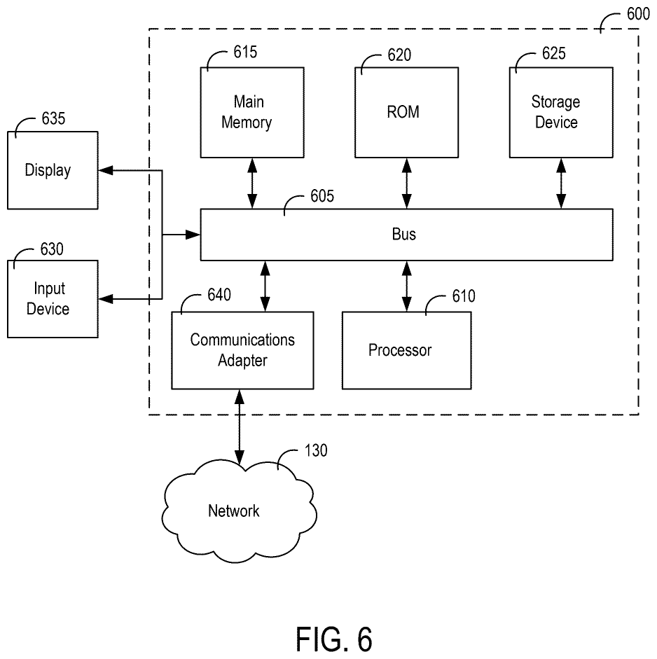

Referring now to FIG. 6, a depiction of a computing system 600 is shown. The computing system 600 may be used/be representative of a computing system for at least one the identity pass system 110, user devices 140, request computing system 150, data sources 160, and/or provider computing system 170. The computing system 600 includes a bus 605 or other communication component for communicating information and a processor 610 coupled to the bus 605 for processing information. The computing system 600 also includes main memory 615, such as a random-access memory (RAM) or other dynamic storage device, coupled to the bus 605 for storing information, and instructions to be executed by the processor 610. Main memory 615 may also be used for storing position information, temporary variables, or other intermediate information during execution of instructions by the processor 610. The computing system 600 may further include a read only memory (ROM) 620 or other static storage device coupled to the bus 605 for storing static information and instructions for the processor 610. A storage device 625, such as a solid-state device, magnetic disk, or optical disk, is coupled to the bus 605 for persistently storing information and instructions.

The computing system 600 may be coupled via the bus 605 to a display 635, such as a liquid crystal display, or active-matrix display, for displaying information to a user. An input device 630, such as a keyboard including alphanumeric and other keys, may be coupled to the bus 605 for communicating information, and command selections to the processor 610. In another arrangement, the input device 630 has a touch screen display 635. The input device 630 may include any type of biometric sensor, a cursor control, such as a mouse, a trackball, or cursor direction keys, for communicating direction information and command selections to the processor 610 and for controlling cursor movement on the display 635.

In some arrangements, the computing system 600 may include a communications adapter 640, such as a networking adapter. Communications adapter 640 may be coupled to bus 605 and may be configured to facilitate communications with a computing or communications network 130 and/or other computing systems. In various illustrative arrangements, any type of networking configuration may be achieved using communications adapter 640, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein may be achieved by the computing system 600 in response to the processor 610 executing an arrangement of instructions contained in main memory 615. Such instructions may be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 6, arrangements of the subject matter and the functional operations described in this specification may be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification may be implemented as one or more computer programs, e.g., one or more subsystems of computer program instructions, encoded on one or more computer storage medium for execution by, or to control the operation of, data processing apparatus. Alternatively, or in addition, the program instructions may be encoded on an artificially generated propagated signal, e.g., a machine generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

Although shown in the arrangements of FIG. 6 as singular, stand-alone devices, one of ordinary skill in the art will appreciate that, in some arrangements, the computing system 600 may include virtualized systems and/or system resources. For example, in some arrangements, the computing system 600 may be a virtual switch, virtual router, virtual host, virtual server. In various arrangements, computing system 600 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

While this specification contains many specific arrangement details and/or arrangement details, these should not be construed as limitations on the scope of any disclosure or of what may be claimed, but rather as descriptions of features specific to particular arrangements and/or arrangements of the systems and methods described herein. Certain features that are described in this specification in the context of separate arrangements and/or arrangements may also be implemented and/or arranged in combination in a single arrangement and/or arrangement. Conversely, various features that are described in the context of a single arrangement and/or arrangement may also be implemented and arranged in multiple arrangements and/or arrangements separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Additionally, features described with respect to particular headings may be utilized with respect to and/or in combination with illustrative arrangement described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims may be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the arrangements and/or arrangements described above should not be understood as requiring such separation in all arrangements and/or arrangements, and it should be understood that the described program components and systems may generally be integrated together in a single software product or packaged into multiple software products.

Having now described some illustrative arrangements, implementations, and embodiments it may be apparent that the foregoing may be illustrative and not limiting, having been presented by way of example. In particular, although many of the examples presented herein involve specific combinations of method acts or system elements, those acts, and those elements may be combined in other ways to accomplish the same objectives. Acts, elements and features discussed only in connection with one arrangement and/or arrangement are not intended to be excluded from a similar role in other arrangements or arrangements.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate arrangements and/or arrangements consisting of the items listed thereafter exclusively. In one arrangement, the systems and methods described herein consist of one, each combination of more than one, or all of the described elements, acts, or components.

Any references to arrangements, implementations, or elements or acts of the systems and methods herein referred to in the singular may also embrace arrangements and/or arrangements including a plurality of these elements, and any references in plural to any arrangement, arrangement, or element or act herein may also embrace arrangements and/or arrangements including only a single element. References in the singular or plural form are not intended to limit the presently disclosed systems or methods, their components, acts, or elements to single or plural configurations. References to any act or element being based at least on any information, act or element may include arrangements and/or arrangements where the act or element may be based at least in part on any information, act, or element.

Any arrangement disclosed herein may be combined with any other arrangement, and references to “an arrangement,” “some arrangements,” “an alternate arrangement,” “various arrangement,” “one arrangement” or the like are not necessarily mutually exclusive and are intended to indicate that a particular feature, structure, or characteristic described in connection with the arrangement may be included in at least one arrangement. Such terms as used herein are not necessarily all referring to the same arrangement. Any arrangement may be combined with any other arrangement, inclusively or exclusively, in any manner consistent with the aspects and arrangements disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing arrangements and/or arrangements are illustrative rather than limiting of the described systems and methods. Scope of the systems and methods described herein is thus indicated by the appended claims, rather than the foregoing description, and changes that come within the meaning and range of equivalency of the claims are embraced therein.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors. In some arrangements, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may include or otherwise share the same processor which, in some example arrangements, may execute instructions stored, or otherwise accessed, via different areas of memory). Alternatively, or additionally, the one or more processors may be structured to perform or otherwise execute certain operations independent of one or more co-processors. In other example arrangements, two or more processors may be coupled via a bus to facilitate independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some arrangements, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the arrangements may include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), math-based currencies (often referred to as cryptocurrencies), and central bank digital currency (often referred to as CBDC). Examples of math-based currencies include Bitcoin, Ethereum, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure may be accomplished with standard programming techniques with rule-based logic and other logic to accomplish the various database searching steps, correlation steps, comparison steps and decision steps.

What is claimed is:

1. A system, comprising:
a first computing system comprising at least one processor and at least one memory coupled to the at least one processor, wherein the at least one processor is configured to:
receive an identity pass request for a user;
receive at least attributes associated with the user;
transmit an authentication request for at least one verifiable credential of the user;
receive the at least one verifiable credential of the user;
generate an identity pass comprising a set of identity tokens and the at least one verifiable credential, wherein the set of identity tokens comprises at least a first identity token comprising attributes of the user;
generate a graphical user interface (GUI) comprising a representation of the identity pass, the identity pass comprising one or more interactive elements, wherein selection of the one or more interactive elements comprises updating the representation corresponding with the identity pass;
receive a data request corresponding with the at least one verifiable credential or at least one of the set of identity tokens of the identity pass, wherein the data request is for an exchange using an exchange instrument, by the user, or providing at least one of the attributes of the user;
verify the at least one verifiable credential based at least on verifying a cryptographic object, an issuer, or a status of the at least one verifiable credential;
responsive to verifying the at least one verifiable credential, determine, the data request, a first subset of the attributes corresponding with protected information of the user and a second subset of the attributes corresponding with unprotected information of the user;
access a data storage storing the identity pass, wherein accessing comprises querying for unprotected information of the user corresponding with the at least one of the set of identity tokens, and wherein the query returns the unprotected information to satisfy the exchange or permit access to at least one of the attributes of the user;
transmit, to a second computing system, the unprotected information to satisfy the data request, or, permit access, to the second computing system, to the unprotected information to satisfy the data request; and
update a usage log of the identity pass corresponding with the data request.

2. The system of claim 1, wherein:
updating the representation of the identity pass comprises presenting the usage log; and
updating the usage log of the identity pass comprises updating the representation of the identity pass in the GUI.

3. The system of claim 1, wherein the identity pass is stored on a distributed ledger and the distributed ledger is a semi-private distributed ledger allowing selective access to the distributed ledger.

4. The system of claim 1, wherein the authentication request is transmitted to the user, a government entity, or third-party.

5. The system of claim 1, wherein the query returns the unprotected information and the at least one processor is further configured to determine, based at least on the data request, a portion of the unprotected information to satisfy the data request.

6. The system of claim 1, wherein the at least one processor is further configured to:
receive a second data request for supplementary information associated with the user;
responsive to user approval, receive the supplementary information;
generate at least a second identity token of the set of identity tokens comprising the supplementary information; and
update the identity pass based at least on the second identity token.

7. The system of claim 1, wherein the at least one processor is further configured to:
verify, using at least one authentication protocol, the data request; and
transmit, to the second computing system, the at least one of the set of identity tokens.

8. A method, comprising:
receiving an identity pass request for a user;
receiving at least attributes associated with the user;
transmitting an authentication request for at least one verifiable credential of the user;
receiving the at least one verifiable credential of the user;
generating an identity pass comprising a set of identity tokens and the at least one verifiable credential, wherein the set of identity tokens comprise at least a first identity token comprising attributes of the user;
generating a graphical user interface (GUI) comprising a representation of the identity pass, the identity pass comprising one or more interactive elements, wherein selection of the one or more interactive elements comprises updating the representation corresponding with the identity pass;
receiving a data request corresponding with the at least one verifiable credential or at least one of the set of identity tokens of the identity pass, wherein the data request is for an exchange using an exchange instrument, by the user, or providing at least one of the attributes of the user;
verifying the at least one verifiable credential based at least on verifying a cryptographic object, an issuer, or a status of the at least one verifiable credential;
responsive to verifying the at least one verifiable credential, determining, based at least on the data request, a first subset of the attributes corresponding with protected information of the user and a second subset of the attributes corresponding with unprotected information of the user;
accessing a data storage storing the identity pass, wherein accessing comprises querying for unprotected information of the user corresponding with the at least one of the set of identity tokens, and wherein the query returns the unprotected information to satisfy the exchange or permit access to at least one of the attributes of the user;
transmitting, to a computing system, the unprotected information to satisfy the data request, or, permitting access, to the computing system, to the unprotected information to satisfy the data request; and
updating a usage log of the identity pass corresponding with the data request.

9. The method of claim 8, further comprising updating the identity pass.

10. The method of claim 8, further comprising generating a second identity token of the set of identity tokens comprising access credentials corresponding to the exchange instrument.

11. The method of claim 8, further comprising:
receiving a second data request for supplementary information associated with the user;
responsive to user approval, receiving the supplementary information;
generating at least a second identity token of the set of identity tokens comprising the supplementary information; and
updating the identity pass based at least on the second identity token.

12. The method of claim 11, wherein the supplementary information is a tax history or credit score.

13. The method of claim 8, wherein the identity pass is stored on a distributed ledger and the distributed ledger is a semi-private distributed ledger allowing selective access to the distributed ledger.

14. The method of claim 8, wherein the identity pass request is generated responsive to an onboarding process.

15. At least one non-transitory processor-readable medium comprising processor-readable instructions such that, when executed by at least one processor, causes the at least one processor to:
receive an identity pass request for a user;
receive at least attributes associated with the user;
transmit an authentication request for at least one credential of the user;
receive the at least one credential of the user;
generate an identity pass comprising a set of identity tokens and the at least one credential, wherein the set of identity tokens comprises at least a first identity token comprising attributes of the user;
generate a graphical user interface (GUI) comprising a representation of the identity pass, the identity pass comprising one or more interactive elements, wherein selection of the one or more interactive elements comprises updating the representation corresponding with the identity pass;
receive a data request corresponding with the at least one credential or at least one of the set of identity tokens of the identity pass, wherein the data request is for an exchange using an exchange instrument, by the user, or providing at least one of the attributes of the user;
verify the at least one credential based at least on verifying a cryptographic object, an issuer, or a status of the at least one credential;
responsive to verifying the at least one credential, determine, based at least on the data request, a first subset of the attributes corresponding with protected information of the user and a second subset of the attributes corresponding with unprotected information of the user;
access a data storage storing the identity pass, wherein accessing comprises querying for unprotected information of the user corresponding with the at least one of the set of identity tokens, and wherein the query returns the unprotected information to satisfy the exchange or permit access to at least one of the attributes of the user;
transmit, to a second computing system, the unprotected information to satisfy the data request, or, permit access, to the second computing system, to the unprotected information to satisfy the data request; and
update a usage log of the identity pass corresponding with the data request.

16. The at least one non-transitory processor-readable medium of claim 15, wherein the at least one processor is further configured to:
receive a second data request for supplementary information associated with the user;
responsive to user approval, receive the supplementary information;
generate at least a second identity token of the set of identity tokens comprising the supplementary information; and
update the identity pass based at least on the second identity token.

17. The at least one non-transitory processor-readable medium of claim 15, wherein the identity pass is stored on a distributed ledger and the distributed ledger is a semi-private distributed ledger allowing selective access to the distributed ledger.

18. The at least one non-transitory processor-readable medium of claim 15, wherein the query returns the unprotected information and the at least one processor is further configured to determine, based at least on the data request, a portion of the unprotected information to satisfy the data request.

19. The at least one non-transitory processor-readable medium of claim 15, wherein:
updating the representation of the identity pass comprises presenting the usage log; and
updating the usage log of the identity pass comprises updating the representation of the identity pass in the GUI.

20. The at least one non-transitory processor-readable medium of claim 15, wherein the at least one processor is further configured to generate a second identity token of the set of identity tokens comprising access credentials corresponding to the exchange instrument.
